(19) United States
(12) Patent Application Publication
(10) Pub. No.: US 2002/0097759 A1
(43) Pub. Date: Jul. 25, 2002

(54) Temperature compensating reflective resonator

(76) Inventor: Bin Zhao, Irvine, CA (US)

Correspondence Address: STRADLING YOCCA CARLSON & RAUTH, IP Department, 660 Newport Center Drive, Suite 1600, P.O. Box 7680, Newport Beach, CA, 92660-6441, US

(21) Appl. No.: 10/016,801

(22) Filed: Nov. 30, 2001

Related U.S. Application Data
(60) Provisional application No. 60/254,388, filed on Dec. 8, 2000.

(51) Int. Cl. H01S 3/098

(52) U.S. Cl. 372/18

(57) ABSTRACT

A temperature compensating reflective resonator has a first light transmissive material and a second light transmissive material. The first and second light transmissive materials cooperate with one another in a manner which mitigates changes in an optical path length of the reflective resonator due to change in temperature.

### PRIORITY CLAIM

This patent application claims the benefit of the filing date of the U.S. Provisional Patent Application No. 60/254,388, filed on Dec. 8, 2000 and entitled REFLECTIVE RESONATOR OF LOW TEMPERATURE DEPENDENCE, the entire contents of which are hereby expressly incorporated by reference.

### CROSS-REFERENCE TO RELATED APPLICATIONS

This Patent Application is related to co-pending patent application Ser. No. ______ filed on Oct. 18, 2001 and entitled INTERLEAVER HAVING GIRES-TOURNOIS RESONATOR (Docket Number 12569-06), and is related to co-pending patent application Ser. No. ______, filed on even date herewith and entitled BIREFRINGENT DEVICES AND FILTERS OF TEMPERATURE COMPENSATION (Docket Number 12569-0008), both of which are commonly owned by the Assignee of this patent, the entire contents of both of which are hereby expressly incorporated by reference.

### FIELD OF THE INVENTION

The field of the invention relates generally to optical devices and relates more particularly to a temperature compensating reflective resonator suitable for use in optical filters and lasing wavelength lockers such as those utilized in optical communication systems.

### BACKGROUND OF THE INVENTION

Optical communications systems which utilize wavelength-division multiplexing (WDM) and dense wavelength-division multiplexing (DWDM) technologies are well known. According to both wavelength division multiplexing and dense wavelength-division multiplexing, a plurality of different wavelengths of light, preferably inferred light, are transmitted via a single medium, such as an optical fiber. Each wavelength corresponds to a separate channel and carries information generally independently with respect to the other channels. The plurality of wavelengths (and consequently corresponding plurality of channels) are transmitted simultaneously without interference with one another, so as to substantially enhance the transmission bandwidth of the communication system. Thus, according to wavelength-division multiplexing and dense wavelength-division multiplexing technologies, a greater amount of information can be transmitted than is possible utilizing a single wavelength optical communication system.

Reflective resonators have various applications in optics and more particularly have various applications in optical communications. Reflective resonators can be used to construct wavelength filters (such as the comb filters or interleavers) for use in wavelength-division multiplexing (WDM) and dense wavelength-division multiplexing (DWDM) optical networks. They can also be used to construct lasing wavelength lockers for laser light sources. Gires-Tournois resonators are one type of reflective resonators which may be utilized in the construction of optical filters and lasing wavelength lockers.

Referring now to FIG. 1, a Gires-Tournois resonator is an asymmetric Fabry-Perot resonator having a partially reflecting front interface 10 and a fully (100%) reflecting back interface 11. The reflection coefficient of the partially reflecting front interface 10 of the Gires-Tournois resonator is designated as r. The distance between the parallel partially reflecting front interface 10 and the fully reflecting back interface 11 is designated as L.

The phase delay between two adjacent reflected beams, such as beam 2 and beam 3 which result form the reflection of beam L is caused by one additional round trip from the partially reflecting front interface 10 to the fully reflecting back interface 11 and back to the partially reflecting front interface 10. This phase delay is δ=4πnL cosθ/λ, where n is the refractive index of the medium between the two parallel interfaces (the partially reflecting front interface 10 and the fully reflecting back interface 11), θ is the angle of incidence for the incoming light beam 1 (inside the medium) and λ is the wavelength of incident light. In many applications, normal incidence, wherein θ=0°, is used and the phase delay becomes δ=4πnL/λ.

For an optical medium, the optical path length (OP) is typically defined as OP=nL, where n and L are the refractive index and the physical distance or length of the medium, respectively. The round trip phase delay is δ=4πOP cosθ/λ=4πOP/λ (for normal incidence θ=0°). The optical path length, and thus the phase delay, depends substantially upon the ambient temperature of the Gires-Tournois resonator, since both the distance L and the refraction index n of the medium tend to vary with temperature.

As those skilled in the art will appreciate, the phase delay δ determines many device performance characteristics when a Gires-Tournois resonator is utilized in the device. For example, the two Gires-Tournois resonators shown in FIGS. 2 and 3 may be utilized so as to construct a channel interleaver for a dense wavelength-division multiplexing (DWDM) communication system. In this instance, the operational parameters of the interleaver are determined by the phase delay δ. With particular reference to FIG. 2, the illustrated Gires-Tournois resonator shown therein has a phase delay of δ as discussed above. However, with particular reference to FIG. 3, the Gires-Tournois resonator shown therein is a special Gires-Tournois resonator wherein r=0%. That is, the front surface does not reflect any of the light incident thereon. The distance between the two parallel interfaces (the front interface interface 10 and the back interface 11) is L/2 for the Gires-Tournois resonator of FIG. 3. The phase delay for the Gires-Tournois resonator shown in FIG. 3 is δ/2. The value of the phase delay δ determines the channel wavelengths of the odd and even channels when such Gires-Tournois resonators are utilized in the construction of optical interleavers. In lasing wavelength lockers, the phase delay δ determines the locked lasing wavelength.

Thus, since the phase delay of such a Gires-Tournois resonator varies substantially with temperature, the performance characteristics of the devices or systems using Gires-Tournois resonators similarly vary substantially with temperature. As stated above, the phase delay varies with temperature because optical path length varies with temp. And the optical path length varies with temperature because the index of refraction n of the medium varies with temperature and also because the thermal expansion of the medium between the partially reflecting front interface 10 and the fully reflecting back interface 11 varies the distance L therebetween.

This temperature dependence of a Gires-Tournois resonator is undesirable in many applications and can introduce intolerable performance and stability characteristics at both the device level and the system level. Thus, there is a need in the art to reduce the temperature dependence of a Gires-Tournois resonator, so as to facilitate the construction of a device which better satisfies the requirements of optical devices and network system.

### SUMMARY OF THE INVENTION

The present invention specifically addresses and alleviates the above mentioned deficiencies associated with the prior art. More particularly, the present invention comprises a temperature compensating reflective resonator comprising a light transmitting material having a front surface and a back surface, a reflector configured to reflect approximately 100% of light incident thereon, and a holder configured to hold the front surface of the light transferring material at approximately fixed distance with respect to the reflector. The light transmitting material, the reflector and the holder are configured so as to define a gap intermediate the back surface of the light transmitting material and the reflector. According to the present invention, the configuration of the reflective resonator and the materials selected for use therein substantially reduce the temperature dependence of the total optical path length of the device.

Thus, a reflective resonator such as a Gires-Tournois resonator, is provided wherein the temperature dependence of performance characteristics thereof is substantially reduced so as to provide a more reliable and temperature stable device.

These, as well as other advantages of the present invention, will be more apparent from the following description and drawings. It is understood that changes in the specific structure shown and described may be made within the scope of the claims without departing from the spirit of the invention.

### BRIEF DESCRIPTION OF THE DRAWINGS

FIG. 1 is a schematic diagram showing a prior art Gires-Tournois reflective resonator;

FIG. 2 is a schematic diagram showing a Gires-Tournois reflective resonator wherein the light transmissive material thereof has a thickness of L, thereby providing a phase delay of δ;

FIG. 3 is a schematic diagram showing a Gires-Tournois reflective resonator wherein the light transmissive material thereof has a thickness of L/2, thereby providing a phase delay of δ/2 and wherein the front surface of the light transmissive material is fully transmissive (special case);

FIG. 4 is a schematic diagram showing a new Gires-Tournois resonator which provides temperature compensation according to the present invention;

FIG. 5 is a schematic diagram showing an alternative configuration of a new Gires-Tournois resonator which provides temperature compensation according to the present invention.

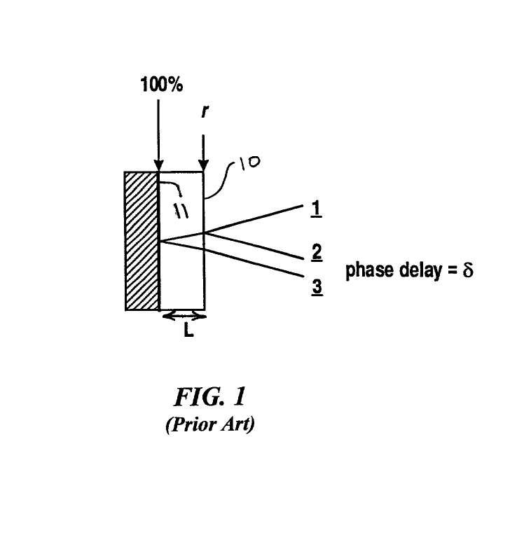

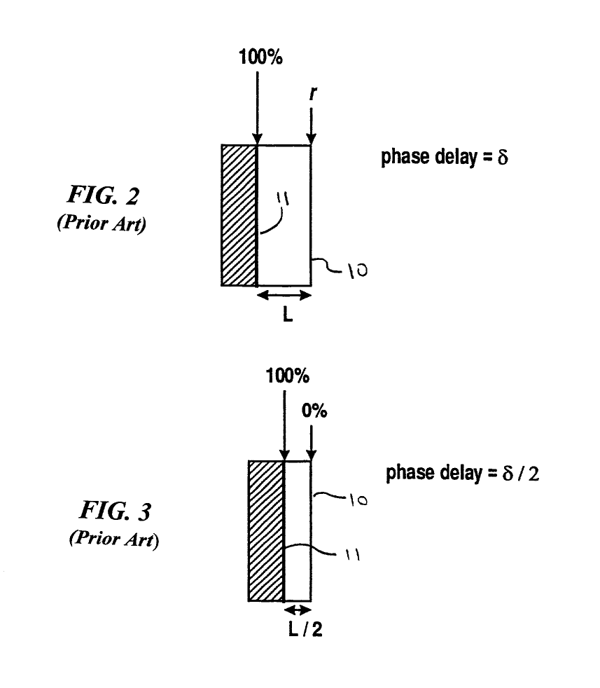

### DETAILED DESCRIPTION OF THE INVENTION

The detailed description set forth below in connection with the appended drawings is intended as a description of the presently preferred embodiments of the invention and is not intended to represent the only forms in which the present invention may be constructed or utilized. The description sets forth the functions of the invention and the sequence of steps for constructing and operating the invention in connection with the illustrated embodiments. It is understood, however, that the same or equivalent functions and sequences may be accomplished by different embodiments that are also intended to encompassed within the spirit and scope of the invention.

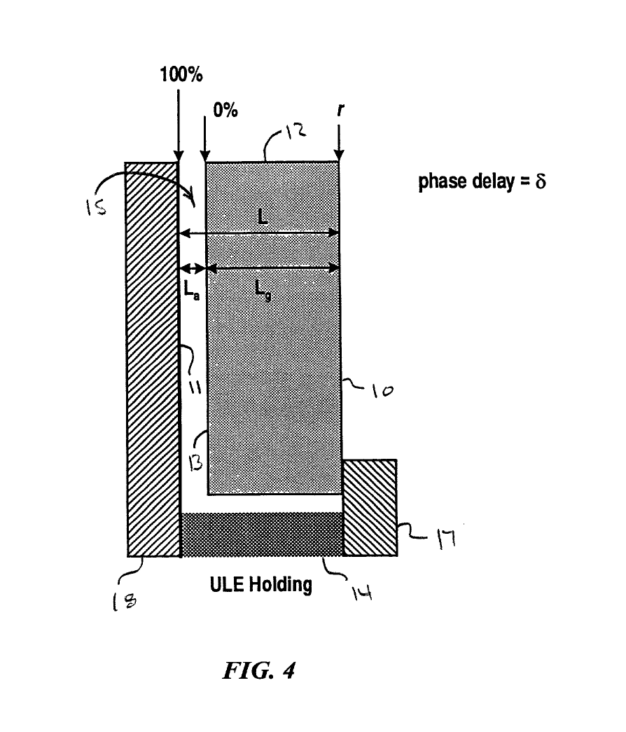

Referring now to FIG. 4, the present invention comprises a temperature compensating reflective resonator comprising a light transmitting material 12 having a front interface or surface 10 configured to reflect some portion of the light incident thereon (this portion can be zero in a spiral case) and a back interface or surface 13; a reflector 11 configured to reflect approximately 100% of light incident thereon; and a holder (14, 17 and 18) configured to hold the front surface 10 of the light transmitting material 12 at approximately a fixed distance with respect to the reflector. The light transmitting material 12, the reflector 11 and the holder (14, 17, 18) are configured so as to define a gap 15 intermediate the back surface 13 of the light transmitting material 12 and the reflector 11. The gap 15 provides space into which the light transmitting material 12 can expand, as the temperature rises. The gap 15 may comprise vacuum, air, or liquid.

The front surface 10 of the light transmitting material 12 preferably has a reflection coefficient r and the back surface 13 of the light transmitting material preferably has a reflection coefficient which is approximately equal to zero. However, as mentioned above, in a special case the reflection coefficient of the front surface 10 may be approximately zero, such that approximately 100% of the light incident thereupon is transmitted into the light transmitting material 12.

The reflector 11 preferably comprises a mirror or similar light reflecting device.

The holder generally comprises a light transmitting material support 17, a spacer 14, and a reflector support 18. The light transmitting material support 17 supports the light transmitting material 12 by contacting the front surface 10 in a manner which allows the front surface 10 of the light transmitting material 12 to remain approximately a fixed distance away from the reflector 11, particularly as temperature changes cause the light transmitting material 12 to contract and/or expand. The light transmitting material support 17 preferably contacts the light transmitting material 12 at or very close to the front surface 10 thereof.

Similarly, the reflector support 18 supports the reflector surface 11. The spacer 14 separates the light transmitting material support 17 and the reflector support 18 by a distance L which remains approximately fixed during ambient temperature changes. The spacer preferably comprises an ultra low expansion material, preferably having a thermal expansion coefficient of approximately 0.1 ppm/° C., although other values may be suitable depending upon the application. Those skilled in the art will appreciate the various other configurations of the light transmitting material support 17, spacer 14, and reflector support 18 may, optionally, comprise a single, unitary structure comprised of an ultra low expansion material and configured so as to maintain the front surface 10 of the light transmitting material 12 approximately a fixed distance away from the reflector 11 during ambient temperature changes.

The thickness of the light transmitting material 12 is much larger than the thickness of the gap 15. The gap 15 only needs to be large enough to accommodate the maximum amount of expansion of the light transmitting material 12 which is anticipated. However, some safe margin should be included in the gap thickness, so as to accommodate unanticipated temperature changes which might otherwise damage the reflective resonator 11 and the non-reflective back surface 13 of light transmitting material 12.

Preferably the light transmitting material, the reflector and the holder cooperate so as to define a Gires-Tournois resonator. However, those skilled in the art will appreciate that the basic configuration of the present invention (wherein two surfaces, at least one of which is formed upon a material having a substantial temperature coefficient of expansion are kept approximately a fixed distance from one another so as to facilitate the use of the light transmissive material to provide a desired phase delay) may find application in various different optical devices.

In addition to air or vacuum, it may be desirable to fill or partially fill the gap 15 with a fluid having a desire refractive index, so as to provide a desired phase delay. Indeed, the gap may optionally be configured such that a fluid contained therein may be changed, such that the phase delay of the device is variable. The gap may optionally be filled with a material, preferably a fluid, which has an index of refraction that varies accordingly with temperature so as to further compensate for the undesirable effects of temperature changes, as discussed below.

According to the present invention, a method for compensating for temperature changes in a reflective resonator comprises providing a plurality (such as two) of light transmissive materials which cooperate with one another in a manner which mitigates changes in a optical path length of the reflective resonator due to changes in temperature. The first light transmissive material preferably comprises a substantially solid material and the second light transmissive material preferably substantially flexible material. For example, the first light transmissive material may comprise glass and the second light transmissive material may comprise vacuum, air, or a transparent liquid.

According to one aspect, the present invention comprises increasing a thickness of a light transmitting material through which light is transmitted, and consequently simultaneously decreasing a thickness of a gap between the light transmitting material and a reflector as temperature varies. The thickness of the light transmitting material varies in a manner which does not substantially vary the distance L between the front surface of the material and a reflector.

As discussed above, the temperature dependence of the performance characteristics of a Gires-Tournois resonator originate from the temperature dependence of the phase delay δ, which in turn depends on the temperature dependence of the optical path length between the two parallel interfaces of the GT resonator. For a single medium, the optical path length is the product of the refraction index n and the length or thickness L of the medium. The product nL is usually called the optical path length for a medium. The temperature dependence of the optical path length (OP) can be written as:

$$\frac{ⅆ OP}{ⅆ T} = \frac{ⅆ ( nL )}{ⅆ T} = \frac{ⅆ n}{ⅆ T} L + n \frac{ⅆ L}{ⅆ T} \qquad ( 1 )$$

The thermal coefficient of optical path length is:

$${α}_{OP} = \frac{1}{OP} \frac{ⅆ OP}{ⅆ T} = \frac{1}{n} \frac{ⅆ n}{ⅆ T} + \frac{1}{L} \frac{ⅆ L}{ⅆ T} = {α}_{n} + {α}_{L} \qquad ( 2 )$$

where αₙ is the thermal coefficient of the refractive index and α_{L} is the thermal expansion coefficient of the medium. For optical glass, a typical medium which is frequently utilized in precision optical instruments, the typical value for αₙ is about 1-2 ppm/° C. and the typical value for α_{L} is about 6-10 ppm/° C., Thus, the thermal coefficient of optical path length is on the order of 10 ppm/° C. for optical glass, which results in significant undesired temperature dependence in device performance characteristics.

In order to reduce the temperature dependence of such a device, a glass material with:

αₙ≈−α_{L} (3)

can be selected for use to substantially reduce the temperature dependence of optical path length. Examples include a glass with αₙ=−1.88 ppm/° C. and α_{L}=1.90 ppm/° C. and another glass with αₙ=−8.5 ppm/° C. and α_{L}8.6 ppm/° C. The resultant thermal coefficients of optical path length are 0.02 ppm/° C. and 0.1 ppm/° C., respectively, for these two examples, which are orders of magnitude less than the original thermal coefficient values. Thus, the temperature dependence of device performance characteristics is significantly reduced. If a glass material is chosen, in which

αₙ=−α_{L} (4)

holds exactly, the temperature dependence is completely eliminated.

As those skilled in the art will appreciate, making a glass material with −αₙ and α_{L} being very close to or equal to each other is usually difficult due to various limitations in material properties and glass synthesis process. Various doping must be carefully adopted and used in the glass to achieve αₙ≈−α_{L} or αₙ=−α_{L}. The following embodiment shows a way to significantly reduce the optical path length thermal coefficient without the constraint αₙ≈−α_{L} or αₙ=−α_{L}.

Referring now to FIG. 4, an exemplary embodiment of a Gires-Tournois resonator, which provides passive temperature compensation according to the present invention, is shown in cross-section. As mentioned above, the Gires-Tournois resonator comprises one partially reflecting front surface 10 having a reflection coefficient r and also comprises a full (100%) reflecting back interface 11. The front interface 10 and back interface 11 are parallel with respect to one another and are separated from one another and held in position with respect to one another, by an ultra-low expansion (ULE) material or spacer 14 having a thermal expansion coefficient α_{ULE} typically on the order of 0.01-0.1 ppm/° C. The distance between the partially reflecting front interface 10 and the full reflecting back interface 11 is L. The distance L is almost constant (does not change much due to temperature changes) because of the use of the ultra-low-expansion material 14 (which has a very low value of thermal expansion coefficient) for holding the partially reflecting front interface 10 in position with respect to the fully reflecting back interface 11.

The ultra-low expansion material or spacer 14 preferably defines the distance between the partially reflecting front interface 10 and the full reflecting back interface 11. The spacer 14 defining a gasket, optical bench, bracket, mount, or other structure which separates and defines the distance between a front mount 17 to which the parallel plate of medium 12 is attached and a rear support 18 upon which the fully reflecting rear interface 11 is formed.

The specific values for the various parameters discussed above and below are by way of illustration only and not by way of limitation. Those skilled in the art will appreciate that the principal of the present invention may be practiced utilizing parameters which are substantially different from those discussed above and below. Further, the structure shown in FIG. 4 is schematic and by way of illustration only. Those skilled in the art will likewise appreciate that various other structures which tend to maintain the partially reflecting front interface 10 at an approximately fixed distance away from the back interface 11 likewise suitable.

It is important to appreciate that, as shown in FIG. 4, the parallel plate of light transmitting material 12, e.g., glass, only partially occupies the space between the partially reflecting front interface 10 and the full reflecting back interface 11. The thickness of the parallel plate is L_{g} and preferably has a value of approximately 1-10 mm. The front surface of this parallel plate 12 is the partially reflecting front interface 10 and the other surface of the parallel plate 12 is a non-reflective interface 13 having a reflection coefficient of zero percent (or approximately zero percent).

A gap 15 is formed between non-reflective interface 13 of the parallel plate of light transmitting material 12 and the fully reflecting back interface or reflector 11. The gap 15 has a thickness Lₐ of approximately 10-200 μm. Preferably, the gap 15 is filled with either air or vacuum.

According to one embodiment of the present invention, the following relationships hold:

L=L_{g}+Lₐ (5)

Lₐ<<L_{g} (6)

Lₐ<<L (7)

L_{g}≈L (8)

The optical path length between the partially reflecting interface 10 and the full back reflecting interface 11 shown in FIG. 4 is given by

OP=n_{g}L_{g}+nₐLₐ≈n_{g}L_{g} (9)

where n_{g} and nₐ are the refractive index of the parallel plate and the refractive index of the gap, respectively. The temperature dependence of the optical path length can be written as

$$\frac{ⅆ OP}{ⅆ T} = \frac{ⅆ {n}_{g}}{ⅆ T} {L}_{g} + {n}_{g} \frac{ⅆ {L}_{g}}{ⅆ T} + \frac{ⅆ {n}_{a}}{ⅆ T} {L}_{a} + {n}_{a} \frac{ⅆ {L}_{a}}{ⅆ T} \qquad ( 10 )$$

Using Eqs. (5)-(10), the thermal coefficient of optical path length is:

$$\begin{matrix}{α}_{OP} = \frac{1}{OP} \frac{ⅆ OP}{ⅆ T} \approx \frac{1}{{n}_{g}} \frac{ⅆ {n}_{g}}{ⅆ T} + \frac{1}{{L}_{g}} \frac{ⅆ {L}_{g}}{ⅆ T} \frac{{n}_{g} - {n}_{a}}{{n}_{g}} + \\ \frac{{L}_{a}}{{L}_{g}} \frac{ⅆ {n}_{a}}{ⅆ T} \frac{1}{{n}_{g}} + \frac{{n}_{a}}{{n}_{g} L} \frac{ⅆ L}{ⅆ T} \\ = {α}_{n} + {α}_{L} \frac{{n}_{g} - {n}_{a}}{{n}_{g}} + {α}_{a} \frac{{n}_{a} {L}_{a}}{{n}_{g} {L}_{g}} + {α}_{ULE} \frac{{n}_{a}}{{n}_{g}}\end{matrix} \qquad ( 11 )$$

where αₐ is the thermal coefficient of refractive index for the gap (either air, vacuum or a fluid), αₙ is the thermal coefficient of refractive index for the parallel plate, α_{ULE} is the thermal expansion coefficient for the spacer 14, and α_{L} is the thermal expansion coefficient for the parallel plate.

The first two terms in Eq. (11) are typically large (on the order of 10 ppm/° C.) as we discussed before the third term in Eq. (11) is small due to the fact nₐLₐ<<n_{g}L_{g} in this design and αₐ is usually about −1 ppm/° C. for air and zero for vacuum. The last term in Eq. (11) is also small because the typical value of α_{ULE} is on the order of 0.01-0.1 ppm/° C. (to keep L almost a constant). To reduce the thermal coefficient of optical path length α_{OP}, a glass material with:

$${α}_{n} \approx - {α}_{L} \frac{{n}_{g} - {n}_{a}}{{n}_{g}} \qquad ( 12 )$$

can be chosen for the parallel plate in the Gires-Tournois resonators. Notice the difference between Eq. (12) and Eq. (3). Eq. (12) can lead to significant reduction in α_{OP}. α_{OP} can be further reduced by proper choices of Lₐ and α_{ULE}, i.e., the gap and the ULE material bring in new freedom to further reduce α_{OP}.

However, it is important to note that L does not necessarily have to be constant. For example, it may be desirable to allow L to vary in a manner which mitigates overall changes in optical path length due to temperature changes. That is, α_{ULE} may be utilized in a manner which compensates for some other parameter which causes the optical path length to change with temperature.

According to one exemplary configuration of the present invention, Ohara Corporation S-FTL51 glass is selected for the parallel plate or the light transmissive medium 12. The related material parameters for S-FTL51 glass are: n_{g}=1.486, dn_{g}/dT=−6.5 ppm/° C., α_{L}=13.3 ppm/° C. A Gires-Tournois resonator as schematically shown in FIG. 4 is designed with Lₐ=100 um, L_{g}=2 mm and ULE material (e.g., Clearcream glass from Ohara Corp.) with α_{ULE}=0.1 ppm/° C. Plug these numbers into Eq. (11) and notice nₐ≈1 and dnₐ/dT≈1 ppm/° C. for the air gap, we can get α_{OP}≈0.01 ppm/° C., which is orders of magnitude less than the original thermal coefficient value of optical path length for the Gires-Tournois resonator. Thus, the temperature dependence of device performance characteristics is significantly reduced.

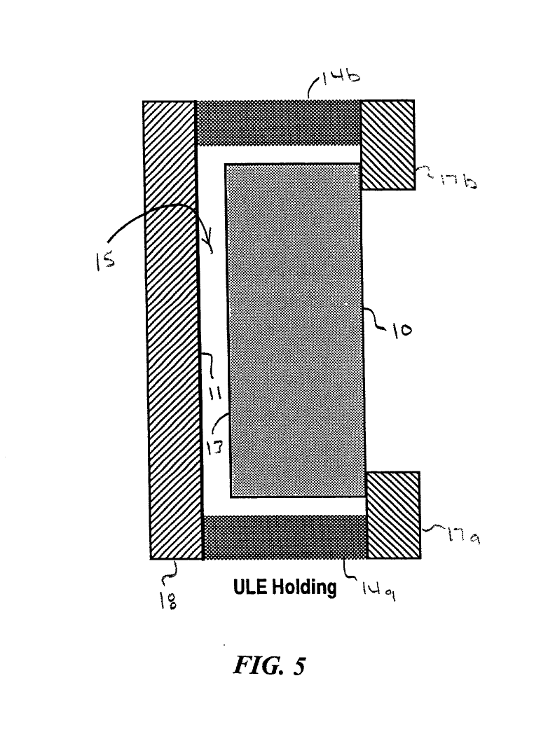

Referring now to FIG. 5, one example of an alternative configuration of the structure of the temperature compensating reflective resonator of the present invention is shown. According to this alternative configuration of the present invention, the ultra-low expansion materials 14a and 14b may comprise either a plurality of separate structures or may alternatively comprise an annular structure (wherein 14a and 14b, are two cross-sectional surfaces of a single annular member.) Similarly, support 17a and 17b may either comprise a plurality of structures or a single annular structure. Those skilled in the art will appreciate that various other configurations are likewise suitable.

The undesirable effects of temperature changes are mitigated according to both embodiments (shown in FIGS. 4 and 5) of the present invention by at least of one of the two following factors. First, undesirable changes in phase delay due to changes in the distance L between the front surface 10 of the light transmissive material 12 and the reflector 11 are mitigated via the use of mounting of the light transmissive material 12 at the front surface 10 thereof so as to facilitate expansion and contraction of the light transmissive material 12 within the distance L (such that the distance L does not change too much during such expansion and contraction) and via the use an ultra low expansion material (α_{ULE} is small) to partially define the holder (14, 17, 18).

According to the present invention, various conditions may be utilized so as to mitigate temperature dependence of the optical path length of a resonant reflector. In each instance, the optical path length of the reflective resonator is made to be more stable with respect to temperature by either reducing individual terms of Eq. (11) or by causing terms or combinations of terms thereof to substantially cancel one another. That is, the temperature dependence of a resonator reflector is mitigated by manipulating the terms of Eq. (11) in a manner which reduces atop.

For example, use of a thermally stable material for the spacer 14 minimizes α_{ULE} and thereby minimizes the fourth term of Eq. (11), so as o consequently reduce α_{OP}.

Further, making L_{g} much greater than Lₐ results in a reduced third term of Eq. (11), thereby reducing α_{OP}.

That is, the light transmissive material 12 is selected such that αₙ is opposite in sign to α_{L}(n_{g}−nₐ)/n_{g} and as close as possible in absolute value thereto.

Terms of Equation (11) may be made to cancel one another by, for example, by selecting a light transmissive material 12 such that αₙ≈−α_{L}(n_{g}−nₐ)/n_{g}(αₙ is the thermal coefficient of refractive index of medium 12, αₙ=(1/n_{g})(dn_{g}/dT); α_{L} is the thermal expansion coefficient of medium 12, α_{L}=(1/L_{g}) (dL_{g}/dT); n_{g} is a refractive index of medium 12 and nₐ is a refractive index of the gap 15. Thus, α_{OP} can be mitigated via selection of the material for the spacer 14 and via the selection of dimensions of Lₐ and L_{g}.

According to one aspect of the present invention, a polarity of light transmissive mediums are used to control the optical path length such that temperature dependence of the optical path length is minimized. For example, one medium, light transmitting material 12, may be allowed to expand into a second, flexible medium, such as air, vacuum, or a fluid which fills the gap 15. Thus, the reflective resonator of the present invention comprises more than one light transmissive medium wherein the light transmissive mediums cooperate in a manner which mitigates temperature dependence of the optical path length thereof.

According to one aspect of the present invention, αₙ, nₐ, Lₐ, αₐ, n_{g}, L_{g}, α_{g}, and α_{ULE} are selected so as to mitigate the temperature dependence of the optical path length of the reflective resonator.

Moreover, it is important to appreciate that L does not necessarily have to be fixed and that α_{ULE} does not necessarily have to be very small (such as less than 0.1 ppm/° C.). Rather, L can be permitted to change, as long as this change is compensated for. As long as at least one other term in Eq. (11) changes in a manner which compensates for such changes in L, then such changes in L may be permitted and are desirable in some cases.

One possible way in which a resonate reflector of the present invention may be constructed so as to mitigate changes in the optical path length thereof due to temperature changes is to configure the reflective resonator such that the first and second terms of Eq. (11) substantially cancel one another, Lₐ is very small with respect to L_{g} such that the third term of Eq. (11) is very small and such that α_{ULE} is as close as possible to zero. In this manner, α_{OP} is minimized and a substantially thermally stable reflective resonator is provided.

However, those skilled in the art will appreciate that the four terms of Eq. (11) may be configured in various other manners so as to similarly minimize op. According to the present invention, the values of the terms of Equation (11) cooperate so as to mitigate the value of α_{OP}. Any combination of terms may cancel or reduce any other combination of terms.

Thus, it is understood that the exemplary temperature compensating reflective resonators described herein and shown in the drawings represent only presently preferred embodiments of the invention. Various modifications and additions may be made to such embodiments, without departing from the spirit and scope of the invention. Indeed, various modifications and additions may be obvious to those skilled in the art and may be implemented to adapt the present invention for use in a variety of different applications.

What is claimed is:

1. A temperature compensating reflective resonator comprising:
a first light transmissive material;
a second light transmissive material; and
wherein the first and second light transmissive materials cooperate with one another in manner which mitigates changes in an optical path length of the reflective resonator due to changes in temperature.

2. The temperature compensating reflective resonator as recited in claim 1, wherein:
the first light transmissive material comprises a substantially solid material; and
the second light transmissive material comprises a substantially flexible material.

3. The temperature compensating reflective resonator as recited in claim 1, wherein:
the first light transmissive material comprises a solid material; and
the second light transmissive material comprises a material selected from the group consisting of:
air;
vacuum; and
liquid.

4. A temperature compensating reflective resonator comprising:
a solid light transmissive material;
a reflector;
a gap formed between the solid light transmissive material and the reflector;
a spacer defining a distance between a front surface of the solid light transmissive material and the reflector;
wherein a thermal coefficient of optical path length is given by the formula
$$\begin{matrix}{α}_{OP} = \frac{1}{OP} \frac{ⅆ OP}{ⅆ T} \approx \frac{1}{{n}_{g}} \frac{ⅆ {n}_{g}}{ⅆ T} + \frac{1}{{L}_{g}} \frac{ⅆ {L}_{g}}{ⅆ T} \frac{{n}_{g} - {n}_{a}}{{n}_{g}} + \\ \frac{{L}_{a}}{{L}_{g}} \frac{ⅆ {n}_{a}}{ⅆ T} \frac{1}{{n}_{g}} + \frac{{n}_{a}}{{n}_{g} L} \frac{ⅆ L}{ⅆ T} \\ = {α}_{n} + {α}_{L} \frac{{n}_{g} - {n}_{a}}{{n}_{g}} + {α}_{a} \frac{{n}_{a} {L}_{a}}{{n}_{g} {L}_{g}} + {α}_{ULE} \frac{{n}_{a}}{{n}_{g}}\end{matrix} \qquad ( 11 )$$
wherein αₙ is the thermal coefficient of the refractive index for the solid light transmissive material, α_{L} is the thermal expansion coefficient for the solid light transmissive material;
n_{g} is index of refraction for the solid light transmissive material, nₐ is the index of refraction for a material dispose intermediate the solid light transmissive material and the reflector, αₐ is the thermal coefficient of refractive index for the material dispose intermediate the solid light transmissive material and the reflector, Lₐ is the distance between the solid light transmissive material and the reflector, L_{g} is the thickness of the solid light transmissive material, and α_{ULE} is the thermal coefficient of expansion for the spacer; and
wherein the thermal coefficient of optical path length is mitigated by at least one of:
minimizing terms of Equation (11);
substantially canceling the terms among one another of Equation (11).

5. A temperature compensating reflective resonator comprising:
a solid light transmissive material;
a reflector;
a gap formed between the solid light transmissive material and the reflector;
a spacer defining a distance between a front surface of the solid light transmissive material and the reflector;
wherein a thermal coefficient of optical path length is given by the formula
$$\begin{matrix}{α}_{OP} = \frac{1}{OP} \frac{ⅆ OP}{ⅆ T} \approx \frac{1}{{n}_{g}} \frac{ⅆ {n}_{g}}{ⅆ T} + \frac{1}{{L}_{g}} \frac{ⅆ {L}_{g}}{ⅆ T} \frac{{n}_{g} - {n}_{a}}{{n}_{g}} + \\ \frac{{L}_{a}}{{L}_{g}} \frac{ⅆ {n}_{a}}{ⅆ T} \frac{1}{{n}_{g}} + \frac{{n}_{a}}{{n}_{g} L} \frac{ⅆ L}{ⅆ T} \\ = {α}_{n} + {α}_{L} \frac{{n}_{g} - {n}_{a}}{{n}_{g}} + {α}_{a} \frac{{n}_{a} {L}_{a}}{{n}_{g} {L}_{g}} + {α}_{ULE} \frac{{n}_{a}}{{n}_{g}}\end{matrix} \qquad ( 11 )$$
wherein αₙ is the thermal coefficient of the refractive index for the solid light transmissive material, α_{L} is the thermal expansion coefficient for the solid light transmissive material;
n_{g} is index of refraction for the solid light transmissive material, nₐ is the index of refraction for a material dispose intermediate the solid light transmissive material and the reflector, αₐ is the thermal coefficient of refractive index for the material dispose intermediate the solid light transmissive material and the reflector, Lₐ is the distance between the solid light transmissive material and the reflector, L_{g} is the thickness of the solid light transmissive material, and α_{ULE} is the thermal coefficient of expansion for the spacer; and
Wherein the thermal coefficient of optical path length is mitigated by configuring the resonate reflector such that the first two terms of Eq. (11) substantially cancel one another, L_{g} is much greater than Lₐ such that the third term of Eq. (11) is approximately zero, and α_{ULE} is substantially zero.

6. A laser frequency locker comprising:
a laser cavity;
at least one reflective resonator disposed at least one end of the laser cavity, the reflective resonator comprising:
a first light transmissive material;
a second light transmissive material; and
wherein the first and second light transmissive materials cooperate with one another in manner which mitigates changes in an optical path length of the reflective resonator due to changes in temperature.

7. A temperature compensating reflective resonator comprising:
a light transmitting material having a front surface and a back surface;
a reflector configured to reflect approximately 100% of light incident thereon;
a holder configured to hold the front surface of the light transmitting material at approximately a fixed distance with respect to the reflector; and
wherein the light transmitting material, the reflector and the holder are configured so as to define a gap intermediate the back surface of the light transmitting material and the reflector.

8. The temperature compensating reflective resonator as recited in claim 7, wherein the light transmitting material comprises glass.

9. The temperature compensating reflective resonator as recited in claim 7, wherein the light transmitting material comprises Ohara Corporation S-FPL51 glass.

10. The temperature compensating reflective resonator as recited in claim 7, wherein:
the front surface of the light transmitting material has a reflection coefficient which is approximately zero or greater than zero; and
the back surface of the light transmitting material has a reflection coefficient which is approximately equal to zero.

11. The temperature compensating reflective resonator as recited in claim 7, wherein the reflector comprises a mirror.

12. The temperature compensating reflective resonator as recited in claim 7, wherein the holder comprises an ultra-low expansion material.

13. The temperature compensating reflective resonator as recited in claim 7, wherein the holder comprises a material having a thermal expansion coefficient of approximately 0.1 ppm/° C.

14. The temperature compensating reflective resonator as recited in claim 7, wherein the holder comprises Ohara Corporation Clearcream glass.

15. The temperature compensating reflective resonator as recited in claim 7, wherein a thickness of light transmitting material is much larger than a thickness of the gap.

16. The temperature compensating reflective resonator as recited in claim 7, wherein the light transmitting material, the reflector and the holder define a Gires-Tournois resonator.

17. A method for mitigating undesirable efforts due to temperative changes in a reflective resonator or the like, the method comprising;
holding a front surface of a light transmitting material approximately a fixed distance from a reflector;
wherein at least two contributing terms of Equation (11) substantially cancel one another; and
wherein the rest of the contributing terms of Equation (11) are approximately minimized.

18. A method for mitigating undesirable effects due to temperature changes in a reflective resonator, the method comprising:
holding a front surface of a light transmitting material approximately a fixed distance from a reflector; and
wherein each contributing term in Equation (11) substantially cancel one another.
